(19) United States
(12) Patent Application Publication
(10) Pub. No.: US 2026/0197661 A1
(43) Pub. Date: Jul. 9, 2026

(54) METHODS AND SYSTEMS FOR UTILIZING NON-TERRESTRIAL NETWORKS TO RESTORE CONNECTIVITY DURING TERRESTRIAL NETWORK OUTAGES

(71) Applicant: T-MOBILE INNOVATIONS LLC, Overland Park, KS (US)

(72) Inventor: Chaitanya CHUKKA, Plainfield, IL (US)

(21) Appl. No.: 19/012,193

(22) Filed: Jan. 7, 2025

(51) Int. Cl. H04W 16/14

(52) U.S. Cl. CPC H04W 16/14

(57) ABSTRACT

Embodiments of the present disclosure are directed to utilizing non-terrestrial networks (NTNs) to restore connectivity during terrestrial network outages. The invention leverages NTNs, such as satellite radio access network (RAN) nodes incorporated into low Earth orbit (LEO) satellites to supplement terrestrial networks when they are compromised. A network monitor receives an indication of an anomalous condition within a terrestrial network. The monitor notifies the network controller of an outage in the terrestrial network. The controller may then direct one or more satellites to provide network connectivity and supplemental coverage. This approach ensures continuous network service during outages caused by natural disasters, power outages, theft, or cyberattacks by utilizing the capabilities of NTNs.

### SUMMARY

The present disclosure is directed to methods and systems for utilizing non-terrestrial networks (NTNs) to restore connectivity during terrestrial network outages.

According to various aspects herein, the invention leverages NTNs, such as satellite radio access network (RAN) nodes incorporated into low Earth orbit (LEO) satellites to supplement or replace terrestrial networks when they are compromised. The method involves detecting an anomalous condition in a terrestrial node and transmitting a notification to a controller. The controller then directs one or more non-terrestrial nodes to establish a communication link with user equipment (UE) within the affected area. This approach ensures continuous network service during outages caused by natural disasters, power outages, theft, or cyberattacks by utilizing the capabilities of NTNs. dynamically assigning space cells to provide emergency services and address outages resulting from weather patterns, natural disasters, and other

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Implementations of the present disclosure are described in detail below with reference to the attached drawing figures, wherein:

FIG. 1 illustrates a computing device suitable for use with implementations of the present disclosure;

FIG. 2 illustrates a representative network environment for use with implementations of the present disclosure;

FIG. 3 illustrates a representative network environment for use with implementations of the present disclosure;

FIG. 4 depicts a flow diagram of a method for use with aspects of the disclosure described herein; and

FIG. 5 depicts a flow diagram of a method for use with aspects of the disclosure described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the terms “base station” or “access point” refer to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies suitable for use with the present disclosure include but are not limited to 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, terrestrial wireless communications networks rely on ground-based infrastructure to provide connectivity. Ground-based infrastructure typically includes cell towers, base stations, fiber-optic cables, radio access, and other equipment that is physically located on or beneath the Earth’s surface. Terrestrial networks are vulnerable to damage from a variety of sources due to their reliance on ground-based infrastructure. Natural disasters, such as hurricanes, earthquakes, floods, and wildfires, can physically destroy cell towers, antennas, and fiber-optic cables, disrupting connectivity across large areas. Power outages that often accompany such events can render network components inoperable, as base stations and core network facilities depend on a stable power supply. Additionally, accidental damage during construction or maintenance, such as cutting fiber-optic cables or unintentionally damaging cell towers, can impair functionality. Vandalism or theft of network equipment, such as copper wiring or batteries, can further impair network functionality. Finally, cyberattacks targeting the core network or communications infrastructure can lead to widespread service disruptions or outages.

Conventionally, when a terrestrial wireless communications network experiences a loss of ground-based infrastructure, wireless communications companies follow a multi-step approach to restore terrestrial networks and provide connectivity to affected areas. First, they must assess the damage to the infrastructure to prioritize repairs and restore services. The areas experiencing a loss of ground-based infrastructure are often difficult to access due to debris, flooding, or damaged roads, which makes the assessment and restoration process more challenging. Next, they deploy temporary solutions such as mobile cell towers to restore coverage temporarily. Aerial solutions, such as drones or balloons, may also be used to provide wireless signals when ground access is difficult. However, these temporary measures often struggle to handle high traffic volumes, leading to network congestion. To maintain power, generators are used, particularly in areas where the power grid is compromised. These generators require a constant supply of fuel, which can be difficult to obtain if roads are blocked or fuel supplies are limited. If fiber-optic cables or other backhaul connections are damaged, microwave links or other wireless technologies may be used as interim solutions. However, microwave signals require a clear, unobstructed path between transmission points, making them vulnerable to physical obstructions.

Unlike conventional solutions, the present disclosure describes utilizing non-terrestrial networks (NTNs) to provide emergency services during outages caused by such as those caused by natural disasters, power outages, theft, or cyberattacks. NTNs refer to networks that utilize space-based infrastructure, such as satellite radio access network (RAN) nodes to provide connectivity. These satellite RAN nodes are physically and functionally incorporated into low Earth orbit (LEO) satellites, which orbit the Earth. The satellite RAN nodes serve the same function as terrestrial RAN nodes, such as communicating with user equipment (UE) and facilitating connection to the core network, but they use the LEO satellites’ orbits to provide positioning and connectivity capabilities. NTNs are crucial in areas where terrestrial infrastructure is sparse or absent, such remote or underserved regions, and can also be used after natural disasters, power outages, theft, or cyberattacks when terrestrial networks are compromised.

Accordingly, a first aspect of the present disclosure provides a method for using one or more non-terrestrial nodes to supplement coverage of a terrestrial node. The method comprises detecting an anomalous condition exists in the terrestrial node. The method further comprises based on the detecting, transmitting a notification of the anomalous condition to a controller used to communicate with non-terrestrial nodes. The method further comprises directing, by the controller, the one or more non-terrestrial nodes to establish a communication link with a user equipment (UE) within a predefined coverage area of the terrestrial node having the anomalous condition.

A second aspect of the present disclosure provides a method for restoring network communication. The method comprises receiving an indication that an anomalous condition exists in a terrestrial node. The method further comprises determining the terrestrial node has failed to connect one or more user equipment (UE) to a core network. The method further comprises sending a positioning command to one or more non-terrestrial nodes. The method further comprises instructing the one or more non-terrestrial nodes to establish a communication link with one or more UE within a predefined coverage area of the terrestrial node having the anomalous condition.

Another aspect of the present disclosure is directed to a system. The system comprises one or more processors. The system further comprises computer memory storing computer-usable instructions that, when executed by the one or more processors, cause the one or more processors to perform operations. The operations comprise identifying a current weather pattern. The operations further comprise retrieving historical network data associated with prior network performance during prior weather patterns. The operations further comprise providing the current weather pattern, current network data, and historical network data associated with the prior network performance during prior weather patterns to a trained adaptive machine learning model. The operations further comprise based on providing the current weather pattern, current network data, and the historical network data associated with the prior network performance during prior weather patterns to the trained adaptive machine learning model, determining that the current weather pattern has a probability of affecting one or more predefined coverage areas.

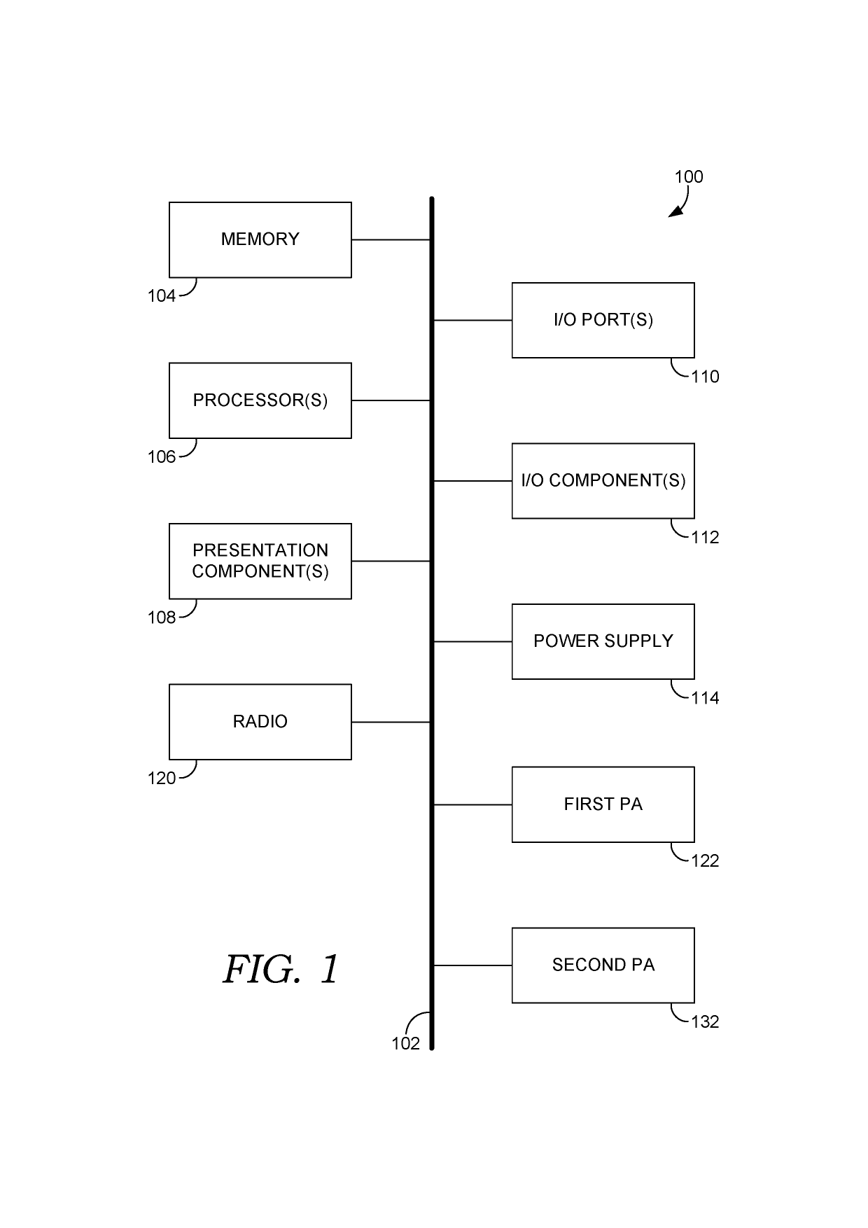

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take the form of a wireless access device that acts as a more localized and consolidated access point that provides end user wireless devices access to a broader network; examples of wireless access devices include fixed wireless access (FWA) devices and mobile hotspots. The computing device 100 may take the form of a mobile device, used herein to refer to categories of often-portable devices that utilize a wireless connection to a broader network and are typically configured for direct human interaction and personal computing tasks; examples of mobile devices include smartphones, tablets, extended reality (XR) device (e.g., augmented reality (AR), virtual reality (VR), and mixed reality (MR)), computers (e.g., laptops and PCs), wearable devices (e.g., smartwatches, fitness tracker), electronic readers (i.e., an e-book reader or digital book reader), portable media player, handheld GPS/location device, digital camera, gaming console, and digital voice recorders. The computing device may take the form of a connected vehicle that integrates advanced communication and computing technologies to interact with other devices and networks, encompassing vehicle to vehicle (V2V) communications, vehicle to infrastructure (V2I) communications, and/or vehicle to everything (V2X) communications, and that utilizes a wireless connection to support telematics, infotainment systems, over the air updates, vehicle health monitoring, and/or enhanced navigation; examples of connected vehicles include automotive, locomotive, airborne, and cargo (e.g., train car, semi-trailer) systems. The computing device 100 may take the form of an Internet of Things (IoT) device, a physical object embedded with sensors, software, or other technologies that enable them to collect, exchange, and act on data using an internet connection, which allows them to perform automated, decision-making or, other content-provision tasks; examples of IoT devices include smart home devices (e.g., smart thermostats, smart lights, power supply/management systems, and smart security systems), connected appliances (e.g., smart refrigerators), health monitoring devices (e.g., blood pressure monitor, glucose monitor), industrial devices (e.g., smart sensors, predictive maintenance systems), and agricultural devices (e.g., soil, environmental, or growth sensors).

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and a second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, 802.11, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

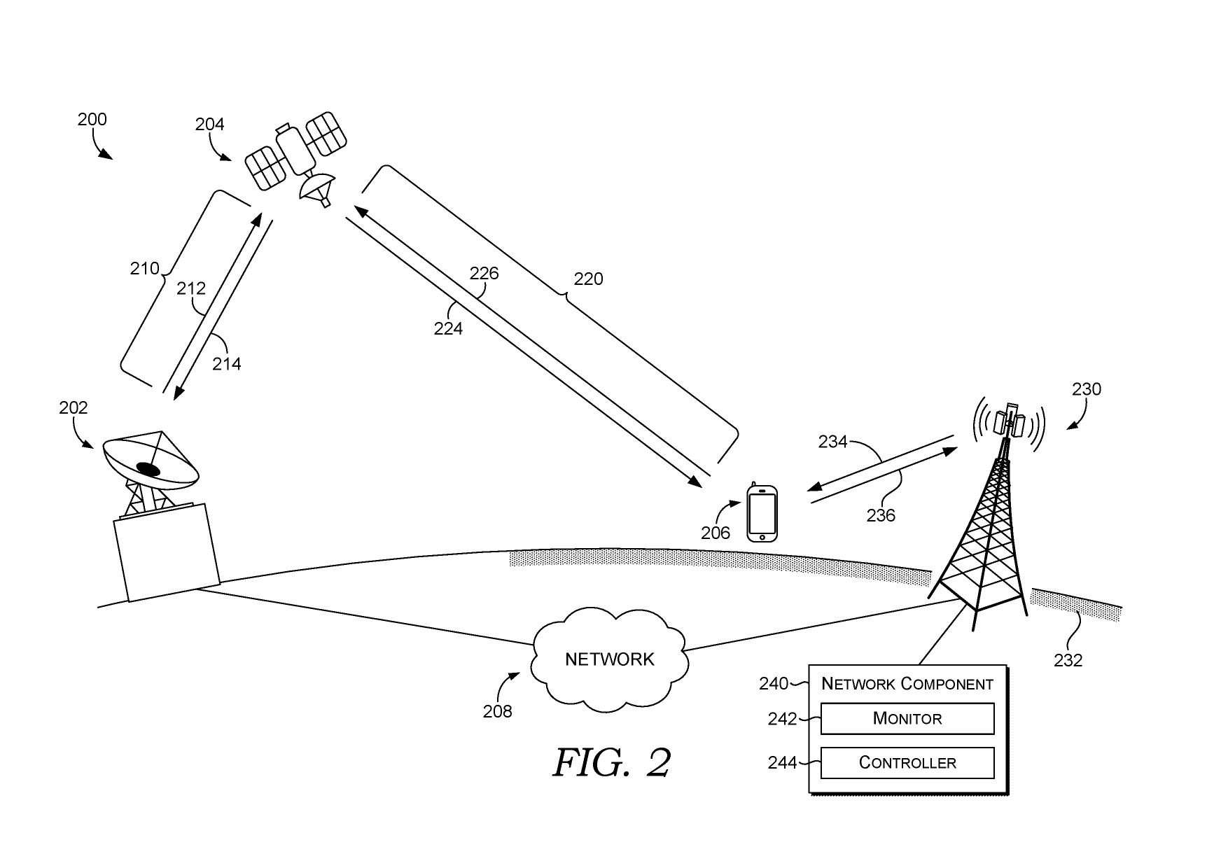

Turning now to FIG. 2, a representative network environment is illustrated in which implementations of the present disclosure may be employed. Such a network environment is illustrated and designated generally as network environment 200. At a high level the network environment 200 comprises a radio access network (RAN), a UE 206, and a network 208. The UE 206 may take on a variety of forms, such as a personal computer (PC), a user device, a smart phone, a smart watch, an extended reality (XR) device, Internet of Things (IoT) device, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device that comprising any one or more feature of computing device 100 of FIG. 1.

In aspects of the present disclosure the RAN may take the form of a non-terrestrial network (NTN), which comprises at least a gateway 202, and a satellite RAN node. The satellite RAN node is physically and functionally incorporated into the satellite 204. For purposes of this disclosure, satellite 204 as referred to herein, comprises a satellite RAN node. In other aspects, the RAN may be associated with a terrestrial network comprising at least the terrestrial base station 230, which comprises the RAN node. The RAN node at the terrestrial base station 230 may be configured to provide wireless communication coverage over at least a portion of a predefined coverage area. Though the composition of network environment 200 illustrates objects in the singular, it should be understood that more than one of each component is expressly conceived as being within the bounds of the present disclosure; for example, the network environment 200 may comprise multiple gateways, multiple distinct networks, multiple UEs, multiple satellites that communicate with a single gateway or multiple gateways, multiple satellites that may have inter-satellite links, multiple terrestrial base stations, and the like. Though certain objects of network environment 200 are illustrated in a certain form, it should also be understood that they may take other forms; for example, even though the UE 206 is illustrated as a cellular phone, a UE suitable for implementations with the present disclosure may be any computing device having any one or more aspects described with respect to FIG. 1, and even though the terrestrial base station 230 is illustrated as a macro cell mounted on a tower, a terrestrial base station suitable for use with the present disclosure is any terrestrial station configured to transmit signals to and receive signals from the UE 206 (e.g., a small cell, pico cell, relay, and the like).

In aspects where the RAN of the network environment 200 is part of a NTN, the gateway 202 may be said to be communicatively connected to the network 208 and the satellite 204. The gateway 202 may be connected to the network 208 via one or more wireless or wired connections and is connected to the satellite 204 via a feeder link 210. The gateway 202 may take the form of a device or a system of components configured to communicate with the UE 206 via the satellite 204 and to provide an interface between the network 208 and the satellite 204. Generally, the gateway 202 utilizes one or more antennas to transmit signals and facilitate data transmission to the satellite 204 via a forward uplink 212 and to receive signals and facilitate data transmission from the satellite 204 via a return downlink 214. The gateway 202 may communicate with a plurality of satellites, including the satellite 204. The network 208 comprises any one or more public or private networks, any one or more of which may be configured as a satellite network, a publicly switched telephony network (PSTN), or a cellular telecommunications network. In aspects, the network 208 may comprise a satellite network connecting a plurality of gateways (including the gateway 202) to other networks, a cellular core network (e.g., a 4G, 5G, of 6G core network, an IMS network, and the like), and a data network. In such aspects, each of the satellite network and the cellular core network may be associated with a network identifier such as a public land mobile network (PLMN), a mobile country code, a mobile network code, or the like, wherein the network identifier associated with the satellite network is the same or different than the network identifier associated with the cellular network.

When present in the network environment 200, the satellite 204 is generally configured to provide wireless communication service to the UE 206. In aspects where the satellite 204 is a bent pipe type, the satellite 204 may primarily operate by relaying communications between the gateway 202 and the UE 206. In aspects where the satellite 204 is processing or regenerative type, the satellite 204 may handle at least some signal processing, routing, switching, and resource allocation/scheduling on board, while still using a connection to the gateway 202 as a backhaul to the network 208. The satellite 204 communicates with the gateway using the feeder link 210 and communicates with the UE 206 using a communication link that is a user link 220. The user link 220 comprises a forward downlink 224 used to communicate signals and facilitate data transmission from the satellite 204 to the UE 206 and a return uplink 226 used to communicate signals and facilitate data transmission from the UE 206 to the satellite 204. The satellite 204 may communicate with the UE 206 using any wireless telecommunication protocol desired by a network operator, including but not limited to 3G, 4G, 5G, 6G, 802.11x and the like. Though shown as having a single beam providing coverage to a satellite coverage area 232, the satellite 204 may be configured to utilize a plurality of individual beams to communicate with multiple different areas at or near the same time. Similarly, though a single forward downlink 224 and a single return uplink 226 are illustrated, the UE 206 may utilize multiple downlinks and/or multiple uplinks to communicate with the satellite 204, using any one or more frequencies as desired by a satellite or network operator. The satellite 204 may be reprogrammed, allowing updates and reconfiguration to maintain performance, minimize interference, and adapt to evolving network conditions in real-time. This is achieved through the network 208, which may send commands to the satellite 204 via the gateway 202, enabling operators to manage satellite positioning, reconfigure payloads, and adapt to changes in service demand or environmental conditions.

Generally, the satellite 204 is characterized by its orbit around the earth. The orbit of any particular satellite will vary by operator desire and/or intended use; for example, a satellite suitable for use with the present disclosure may be characterized by its maximum orbital altitude and/or orbital period as Low Earth Orbit (LEO), Medium Earth Orbit (MEO), and High Earth Orbit (HEO) – also referred to herein as characterizing an orbital plane. Though not rigidly defined, an LEO satellite may orbit with a maximum orbital altitude of less than approximately 1,250 miles, an MEO satellite may orbit with a maximum orbital altitude generally between 1,250 and 22,000 miles, and an HEO satellite may orbit with a maximum orbital altitude of greater than approximately 22,000 miles. In some, but not all cases, a satellite in HEO may be considered geosynchronous (i.e., geosynchronous earth orbit (GEO)) on the basis that its orbital period is approximately equal to the length of a sidereal or solar day (approximately 24 hours); generally, a satellite in geosynchronous orbit will appear to be in the same position relative to a fixed point on the surface of the Earth at the same time each day. A geostationary orbit is a special type of geosynchronous orbit located directly above Earth’s equator. A geostationary orbit has zero eccentricity and zero inclination. As used herein, inclination is used to describe the tilt of the satellite in orbit relative to a reference plane, usually the equatorial plane of Earth. The inclination is measured as the angle between the orbital plane of a satellite and the equatorial plane. As used herein, eccentricity quantifies the shape of an orbit by comparing the distance between the orbit’s two focal points and the length of its major access. A geostationary orbit with zero eccentricity and zero inclination makes the satellite appear stationary from the perspective of an observer on Earth. Some satellites in HEO and all that are in LEO or MEO have an orbital period that is less than the length of a sidereal/solar day, are considered to be non-geosynchronous, and do not remain stationary relative to a fixed position on the surface of the Earth. As used herein, a satellite in LEO has a lower orbital plane than a satellite in MEO or HEO, an MEO satellite has a higher orbital plane than a satellite in LEO, and an HEO satellite has a higher orbital plane than a satellite in LEO or MEO.

LEO satellites may track weather patterns or events, and they are increasingly used for this purpose due to their close proximity to Earth and high-resolution imaging capabilities. LEO satellites orbit Earth quickly, often completing a full orbit in about 90 to 120 minutes. This rapid orbiting allows them to provide frequent updates and detailed images of specific regions, which is highly beneficial for monitoring dynamic weather patterns. With multiple satellites working together in a satellite constellation, LEO systems can provide frequent revisits to any given area, enabling near real-time monitoring of rapidly changing weather patterns.

In aspects where the RAN of the network environment 200 comprises a terrestrial wireless telecommunication network, the network environment 200 comprises one or more terrestrial base stations, represented by terrestrial base station 230. The terrestrial base station 230 is generally configured to relay communications between the network 208 and one or more UEs, such as the UE 206. The terrestrial base station 230 communicates signals to the UE 206 using a terrestrial downlink 234 and receives signals from the UE 206 using a terrestrial uplink 236. The terrestrial base station 230 may communicate with the UE 206 using any wireless telecommunication protocol desired by a network operator, including but not limited to 3G, 4G, 5G, 6G, 802.11x and the like. Though shown as having a single beam providing coverage to a predefined coverage area 232, the terrestrial base station 230 may be configured to utilize a plurality of individual beams to communicate with multiple different areas at or near the same time. Similarly, though a single terrestrial downlink 234 and a single terrestrial uplink 236 are illustrated, the UE 206 may utilize multiple downlinks and/or multiple uplinks to communicate with the terrestrial base station 230, using any one or more frequencies as desired by a mobile network operator.

The satellite 204, gateway 202, and the terrestrial base station 230 are communicatively coupled to the network component 240. The network component 240 may be said to comprise two functionally-defined modules; such a composition is representative only, more or fewer sub-components or modules may be utilized to perform the functionality described herein. Said modules comprise a monitor 242 and a controller 244. Together, the network component 240 allocates radio resources to devices based on one or more of their reported capabilities.

The monitor 242 is generally configured to monitor attached device capabilities. In order to determine the UE 206’s capabilities, the monitor 242 is configured to process a UE capability message received from the UE 206. The UE capability message provides detailed information about the UE 206’s technical capabilities, which the serving RAN node (e.g., the terrestrial base station 230, the gateway 202, or the satellite 204) or the network 208 uses to optimize service delivery and resource allocation. The UE capability message is typically sent during the initial attachment process when the UE 206 connects to the serving RAN node or during handover between cells or networks. It can also be requested by the network at any time to reassess the capabilities of the UE 206, particularly when there are changes in network configuration or when the network needs to optimize the allocation of resources.

In addition to monitoring device capabilities, the monitor 242 is configured to monitor performance of the serving RAN node. Though a Mobile Network Operator (MNO) may utilize many different metrics or key performance indicators (KPIs) as a basis for determining performance of a serving RAN node, some representative metrics or KPIs include frequency band utilization, packet loss rate, latency, jitter, a packet error rate, bandwidth utilization, number of connected UEs, and traffic load. The monitor 242 may determine an anomalous condition exists at the RAN node based on a determination that one or more metrics of KPIs exceed one or more respective thresholds. Frequency band utilization refers to the proportion or percentage of the available spectral bandwidth within a given frequency band that is actively being used for data transmission. Packet loss rate is the percentage of data packets that are transmitted but fail to reach their destination due to network congestion, errors, or other transmission issues. Latency is the time delay between the transmission of a data packet from the source and its reception at the destination. Jitter is the variation in time delay between consecutive packets arriving at their destination. Packet Error Rate is the ratio of data packets that are received with errors to the total number of packets transmitted. Bandwidth utilization refers to the proportion of the available network bandwidth that is actually being used for data transmission, typically expressed as a percentage. The number of connected UEs refers to the total count of devices that are actively connected and communicating with the serving RAN node at any given time. Traffic load is the total amount of data traffic that the network 208 or the serving RAN node is handling at a given time, including the cumulative data rate. The monitor 242 may track signals and performance metrics sent by the RAN node. If the RAN node stops transmitting these signals, or if significant anomalies like a sudden drop in traffic or connectivity are detected, the monitor may trigger an alert indicating an outage. The monitor 242 may further determine the root cause of an anomalous condition at the RAN node, which includes identifying one or more factors contributing to the anomalous condition.

The controller 244 receives RAN node performance information from the monitor 242 and is generally configured to make resource allocation decisions based on the performance information. In an embodiment, the monitor may 242 detect an anomalous condition in a terrestrial RAN node, for instance, a RAN node located on or integrated with base station 230, wherein the RAN node is responsible for enabling radio access and connectivity within a predefined coverage area 232. As described herein, the anomalous condition may be detected at the RAN node based on a determination that one or more metrics of KPIs exceed one or more respective thresholds. For example, the anomalous condition may be determined to be a weather-related outage, a hardware malfunction, a backhaul failure, congestion, or excessive load. In response to the monitor 242 detecting an anomalous condition at the base station 230, the controller 244 may assess the current network 208 status and calculate the requirements for maintaining connectivity in the predefined coverage area 232. The controller 244 may determine a need for one or more satellites 204 to replace the base station 230 as the serving RAN node for the predefined coverage area 232. In making this determination, the controller 244 may evaluate the current availability, capacity, and coverage of terrestrial and non-terrestrial RAN nodes within the network environment 200. Based on this assessment, the controller 244 may identify at least one satellite 204 capable of effectively assuming the role of the serving RAN node for the predefined coverage area 232. In choosing which satellites 204 may serve the RAN node for the predetermined coverage area 232, the controller 244 may considering factors such one or more satellites’ 204 current orbital positions, beam coverage, available capacity, and signal strength capacities. Once the controller 244 has determined one or more satellites 204 capable of effectively assuming the role of the serving RAN node for the predefined coverage area 232, the controller 244 may generate and send control and configuration instructions to the gateway 202. The gateway 202 may then utilize one or more antennas to transmit forward uplink signals 212 carrying the control and configuration instructions to the one or more satellites 204. These instructions may include parameters for configuring the one or more satellites 204 to establish user links 220 with UE 206 in the predefined coverage area 232. Once instructions are received by one or more satellites 204, the one or more satellites 204 may begin executing the instructions. For example, the one or more satellites 204 may begin transmitting forward downlink signals 224 to the UE 206 and receiving return uplink signals 226 from the UE 206. The one or more satellites 204 may then relay the signals and data received from the UE 206 to a core network, such as the network 208, using a feeder link 210 to communicate with gateway 202, which serves as an interface between one or more satellites 204 and the network 208.

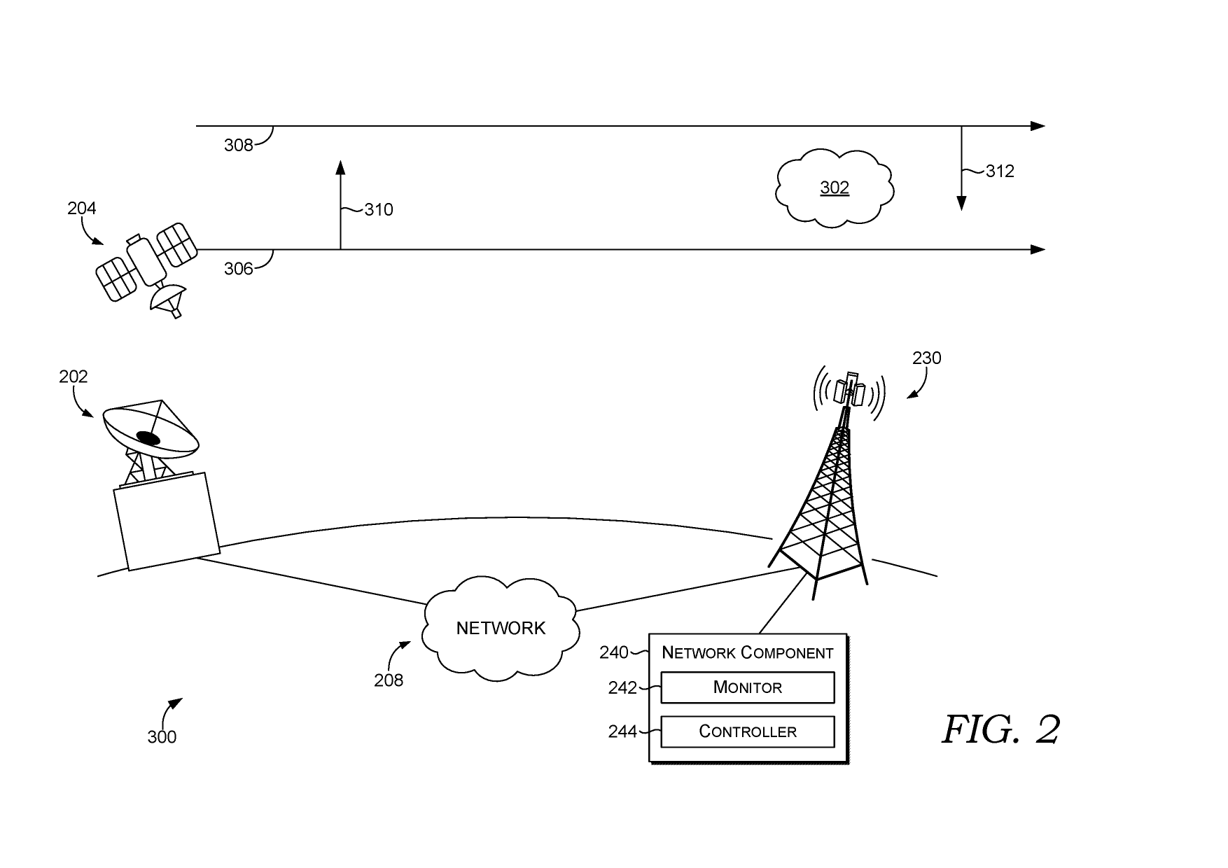

In an embodiment, the monitor 242 may detect an anomalous condition in a terrestrial RAN node located on or integrated with base station 230. The monitor 242 may transmit a notification of the anomalous condition to the controller 244, which may then adjust resources by determining one or more satellites 204 are needed to take over as the serving RAN node. The controller may then identify one or more satellites 204 capable of replacing the terrestrial RAN node as the serving RAN node. In aspects, if there are no satellites 204 in current orbit which can sufficiently cover the predefined coverage area 232, the controller 244 may determine that orbital adjustments are required. Turning now to FIG. 3, a representative non-terrestrial network (NTN) environment is illustrated in which implementations of the present disclosure may be employed. Such a network environment is illustrated and designated generally as network environment 300. The monitor 242 may receive an indication of an anomalous condition at a terrestrial node and may determine the terrestrial node has failed to connect one or more UE within the predefined coverage area 232 to the core network. The monitor 242 may communicate, to the controller 244, the indication of an anomalous condition at a terrestrial node and/or the failure of the terrestrial node to connect one or more UE to the core network. Based on the indication from the monitor 242 to the controller 244, the controller 244 may send a positioning command at a first point in time, 310 to one or more satellites 204 traveling along a first orbital plane 306, to adjust their positioning by maneuvering into a second orbital plane 308 and establishing a link with one or more UE within the predefined coverage area 232. This maneuver may involve calculating the specific adjustments required, such as changes to orbit, orientation, trajectory, altitude, inclination, or velocity to position the one or more satellites 204. Such adjustments may be based on operational requirements.

The monitor 242 may receive an indication the anomalous condition at the terrestrial node no longer exists and/or the terrestrial node is capable of connecting one or more UE within the predefined coverage area 232 to the core network. The monitor may communicate, to the controller 244, the anomalous condition at the terrestrial node no longer exists and/or the terrestrial node is capable of connecting one or more UE to the core network. Based on the indication from the monitor 242 to the controller 244, the controller 244 may send a positioning command at a second point in time 312 to one or more satellites 204 traveling along the second orbital plane 308 to terminate the communication link with the one or more UEs and to adjust their positioning by maneuvering into the first orbital plane 306. This maneuver may involve calculating the specific adjustments required, such as changes to orientation, trajectory, altitude, inclination, or velocity, to position the one or more satellites 204. Such adjustments may be based on operational requirements. The controller 244 may instruct the terrestrial RAN node located at the base station 230 to establishing a link with one or more UE within the predefined coverage area 232.

For example, the anomalous condition may be determined, by the monitor 242, to be a current weather pattern 302, such as a hurricane or heavy snowstorm, impacting the terrestrial RAN node located at the base station 230. This condition may result in degraded signal strength, hardware failure, or complete loss of connectivity for UE 206 within the predefined coverage area 232. In response, the monitor 242 may notify the controller 244 of the anomalous condition, prompting the controller 244 to evaluate available network 208 resources, including non-terrestrial RAN nodes. Upon determining there are no satellites 204 currently in orbit which have sufficient beam coverage or capacity to fully serve the predefined coverage area 232, the controller 244 may prepare to direct one or more satellites 204 to perform orbital maneuvers, which alter the one or more satellites 204 orbit, orientation, trajectory, altitude, inclination, or velocity to transition from a first orbital plane 306, to a second orbital plane 308. The second orbital plane may be optimized to enable the one or more satellites 204 to establish and maintain beam coverage over the area predefined coverage area 232 impacted by the weather pattern 302. These maneuvers may involve precise calculations for changes in velocity and trajectory, taking into account critical factors such as fuel availability, orbital stability, and minimization of handover disruption to other coverage areas. Once the necessary orbital adjustments are determined by the controller 244, the controller 244 may generate and transmit, at a first point in time 310, control instructions to the gateway 202, which may relay the instructions to one or more satellites 204 via forward uplink signals 212. Upon receiving the instructions, the one or more satellites 204 may execute the orbital maneuvers, thereby adjusting their position to establish beam coverage over the predefined coverage area 232. Following the repositioning, the one or more satellites 204 may begin transmitting forward downlink signals 224 to UE 206 and receiving return uplink signals 226 from UE 206, effectively restoring connectivity and ensuring network reliability despite the effects of the current weather pattern 302 on the network’s 208 terrestrial infrastructure.

The monitor 242 may detect the anomalous condition affecting the base station 230 no longer exists, restoring its capability to serve as the RAN node for the predefined coverage area 232. The monitor 242 may notify the controller 244 of this status change, providing updated performance metrics indicating the base station 230 is ready to resume operations. In response, the controller 244 may assess the current network 208 configuration and determine that the one or more satellites 204 currently serving the predefined coverage area 232 can relinquish their role and return to the first orbital plane 306. The controller 244 may then calculate the necessary orbital adjustments to reposition the one or more satellites 204 from the second orbital plane 308 to the first orbital plane 306, considering factors such as fuel optimization, orbital stability, and coordination with other satellites to avoid coverage disruptions in adjacent areas. One the adjustments are determined, the controller 244 may generate and transmit, at a second point in time, the control instructions to the gateway 202, which may relay the instructions to the one or more satellites 204 via forward uplink signals 212. Upon receiving the instructions, the one or more satellites 204 may execute the maneuvers to return to the first orbital plane 306, resuming their original operational configuration and ensuring efficient utilization of network resources. The base station 230 may reestablish its role as the serving RAN node, restoring direct connectivity between the UE 206 and the network 208 within the predefined coverage area 232.

In aspects, the controller 244 may evaluate available network 208 resources and determine that one or more satellites 204 is already positioned to provide immediate assistance, with sufficient capacity and beam coverage to partially support for the predefined coverage area 232. However, the controller 244 may also determine that additional resources are required to ensure full coverage and capacity for the affected area. In this scenario, the controller 244 may identify one or more additional satellites 204 that are not currently positioned to fully serve the predefined coverage area 232 but that can be repositioned. The controller 244 may calculate the necessary orbital adjustments for these additional satellites 204, including changes to their orbits, altitudes, inclinations, or velocities, to achieve optimal coverage. For example, one or more satellites 204 in a neighboring orbital plane, which may be the first orbital plane 306, may need to adjust its orbital plane to the second orbital plane 308 to provide coverage to the predefined coverage area 232. In further examples, one or more satellites 204 in a neighboring orbital plane may need to adjust its inclination to increase overlap with the predefined coverage area 232, while one or more satellites 204 may need to shift its longitudinal position for additional beam coverage. It should be understood that multiple satellites 204 may need to adjust their orbital plane, inclination, longitudinal position, or any combination thereof to achieve optimal coverage. Any and all such combinations of adjustments are contemplated herein to ensure seamless connectivity and efficient resource utilization.

Once these adjustments are determined, the controller 244 may generate control instructions directing one or more additional satellites 204 to provide supplemental coverage in the predefined coverage area and transmit them via the gateway 202, which may relay the instructions to the one or more satellites 204 using forward uplink signals 212. Upon receiving the instructions, the one or more satellites 204 may execute the orbital adjustments and, once repositioned, begin transmitting forward downlink signals 224 to the UE 206 and receiving return uplink signals 226, ensuring uninterrupted connectivity for the predefined coverage area 232. This coordinated effort between the monitor and controller 244 enables the network to respond dynamically to disruptions, leveraging both available and one or more repositioned satellites 204 resources to maintain service quality and reliability.

In aspects, the one or more satellites 204 may form part of a larger satellite constellation, comprising multiple satellites strategically positioned in various orbital planes to provide seamless global or regional coverage. The controller 244, in managing the constellation, may direct multiple satellites within the constellation to adjust their positioning dynamically to address changes in network 208 demands. For example, when a predefined coverage area 232 requires additional resources due to an anomalous condition, such as a disruption at the terrestrial RAN node, the controller 244 may instruct a subset of satellites 204 to maneuver into positions that enable them to provide beam coverage over the predefined coverage area 232 and serve as the RAN node. Concurrently, other satellites within the constellation may be directed to shift their orbits, altitudes, inclinations, or longitudinal positions to replace the repositioned satellites 204, thereby maintaining coverage continuity. This coordinated adjustment ensures that the constellation operates in an integrated system, with satellites 204 dynamically reallocated to balance coverage demands and maintain network 208 reliability across all affected regions. By leveraging the constellation’s flexibility, the controller 244 can optimize resource allocation and minimize disruption, enabling the network to adapt to evolving conditions in real time.

In accordance with the embodiments described herein, the network component 240 may incorporate one or more algorithms. The monitor 242, assisted by an algorithm, may evaluate device capabilities and the performance of the serving RAN node, as described herein. The monitor 242, assisted by an algorithm, may analyze complex data in real time, predicting issues and enabling actionable insights. The monitor 242, when assisted by an algorithm, may analyze complex relationships between KPIs, detecting anomalies in subtle patterns across metrics. For example, the monitor 242, assisted by an algorithm, may recognize that a particular combination of KPIs may indicate an emerging problem, even if no single metric exceeds its threshold. The monitor 242, assisted by the incorporation of an algorithm, may classify anomalies based on patterns it has learned and predict potential anomalies before they happen. For example, the monitor 242, assisted by an algorithm, may predict that a base station will fail based on historical performance during weather patterns, allowing the system to take preventative actions.

The controller 244, assisted by an algorithm, may calculate and execute resource allocation and system organization as described herein. The controller, 244, assisted by an algorithm, may analyze complex scenarios, predict future resource requirements, and dynamically optimize the network, ensuring connectivity. The controller 244, when assisted by an algorithm, may analyze multiple dynamic factors, such as satellite capacity, orbit, latency, and UE distribution to make optimized, context-aware decisions. For example, the controller 244, assisted by an algorithm, may prioritize a satellite 204 with slightly higher latency but more available capacity to prevent network 208 congestion. The controller 244, assisted by an algorithm, may proactively deploy satellites or reallocate resources before an anomaly impacts the network. For example, the controller 244, assisted by an algorithm, may analyze weather data and patterns and preemptively maneuver satellites 204 into position to mitigate predicted outages caused by weather patterns. The controller 244, assisted by the incorporation of an algorithm, may dynamically select the most suitable satellite(s) 204 based on advanced metrics, such as real-time traffic load, UE density, and signal quality. The controller 244, assisted by the incorporation of an algorithm, may coordinate multiple satellites to collaboratively serve the predefined coverage area 232, optimizing beam overlap and capacity sharing.

In further aspects, a machine learning model (MLM) may be integrated into the operations of the monitor 242 to enhance network performance monitoring and decision making processes, particularly under certain environmental or weather conditions. The monitor 242, assisted by the MLM, may operate by identifying patterns in data to make predictions or decisions without being explicitly programmed for specific tasks. The model may undergo a training phase, during which it is exposed to a dataset containing inputs and corresponding outputs. During training, the model may adjusts its internal parameters, such as weights and biases, to minimize error and improve accuracy in predicting outputs based on inputs. Once trained, the model may transition to the inference phase, where it processes new, unseen data to generate predictions or classifications based on the patterns it has learned. The model’s performance may be iteratively refined through techniques such as cross-validation, hyperparameter tuning, and additional training on updated datasets, enabling it to adapt and improve over time.

Integrated MLMs may range from simple algorithms like linear regression to complex architectures such as deep neural networks. Historical data on cell site performance alongside environmental or weather patterns such as rainfall, wind speed, and temperature may be analyzed by the monitor 242, assisted by the MLM. This data is preprocessed to align weather patterns with recorded outages, ensuring the model can recognize correlations. Time-series models can be effective for learning these temporal relationships while spatial models can capture the geographic impact of severe weather. The MLM is trained with labeled outage events to learn patterns associated with disruptions, allowing it to recognize factors that typically precede outages. By testing and refining the model on additional data, the monitor 242, assisted by the MLM, may provide reliable predictions, enabling operators to take preventative action to mobilize satellites 204 before weather-related disaster strikes.

The MLM may be adaptive and trained using historical network performance data, current network metrics, and external environmental inputs, such as weather patterns, and therefore may be configured to identify correlations between weather patterns and network performance. Historical network performance data may include metrics related to availability of power, connectivity status, and coverage area performance. Historical network performance during certain weather patterns may provide valuable insight into how the network responds to various conditions, such as heavy rain, snowstorms, high winds, wildfires, or earthquakes. By analyzing this historical data, patterns of network degradation, such as increased latency, reduced signal strength, higher packet loss rates or outages, may be identified and correlated with specific events. In some cases, severe conditions may also physically damage components of the terrestrial network, such as base station 230 antennas, power supplies, or backhaul infrastructure, leading to prolonged disruptions. For example, wildfires may damage fiber-optic cables or power lines, while earthquakes may disrupt tower stability or communication links. Understanding these potential vulnerabilities may allow the monitor 242 to anticipate scenarios where additional network resources, such as satellite 204 coverage, may be required to maintain connectivity and mitigate disruptions effectively. This information enables the monitor 242 to predict how similar environmental events may impact current network performance, including which coverage areas are most likely to be affected and which network resources are most susceptible to disruption.

In aspects, a trained adaptive machine learning model may be incorporated in the network component 240 to enhance the monitor’s 242 ability to detect and classify anomalous conditions in a RAN node, such as the one integrated with base station 230. This may include not only the anomaly type but also predicted impacts on the predefined coverage area 232 and predicted impacts on additional coverage areas. This may involve determining the root cause of an anomalous condition, wherein determining the root cause includes identifying one or more factors contributing to the anomalous condition based on historical network data and environmental data. For example, the monitor 242, equipped with one or more processors and memory storing computer-usable instructions, may utilize this trained MLM to identify a current weather pattern that may result in degradation of performance at the base station 230. The network component 240 may retrieve historical network data associated with prior network performance during prior weather patterns and integrate this information with real-time network performance metrics. In providing the current weather pattern, current network data, and historical network data associated with prior network performance during prior weather patterns to the monitor 242, assisted by the MLM, the monitor 242 may analyze patterns and correlations to predict the impact of the weather event on one or more predefined coverage areas. The monitor 242 may predict potential anomalous conditions in additional coverage areas within the network 208. For example, the MLM may recognize atmospheric pressure drops, shifting wind patterns, or increased precipitation levels as precursors to severe storms that historically have led to performance degradation in specific coverage areas. The monitor 242, assisted by the MLM’s prediction capability enables proactive network adjustments to mitigate potential disruptions, as further described herein.

The controller 244 may also utilize a trained adaptive MLM to perform the process of making resource allocation decisions based on the performance information received from the monitor 242. The controller 244, assisted by the MLM, may evaluate the network requirements for the predefined coverage area 232, and determine the one or more optimal satellites 204 to take over as the serving RAN node in accordance with aspects described herein. The controller 244, assisted by the MLM, may consider each satellite’s current orbit, beam coverage overlap with the predefined coverage area 232, available capacity, and signal strength capabilities of available satellites 204. The MLM may be further trained on historical network data, enabling it to predict the availability and suitability of potential satellites 204 to act as replacement RAN nodes.

In addition to its predictive capabilities, the trained adaptive MLM may assist the controller 244 in optimizing satellite constellation management under rapidly changing network conditions. By incorporating real-time data on environmental conditions, such as weather patterns, and network performance metrics, the controller 244, assisted by the MLM, may dynamically adjust its decision-making process to account for unexpected disruptions or shifts in resource demands. For example, the controller 244, assisted by the MLM, may predict the need for coordinated orbital adjustments involving multiple satellites 204 within the constellation, ensuring that coverage gaps are minimized while maintaining overall constellation efficiency. Further, the controller 244, assisted by the MLM, may prioritize resource allocation by evaluating multiple predefined coverage areas simultaneously, balancing the competing demands of various regions. This advanced functionality allows controller 244 to operate as an integral part of an adaptive system, capable of refining its predictions and recommendations over time to respond to evolving network and environmental challenges.

In accordance with aspects herein, the monitor 242, assisted by the MLM, may identify a current weather pattern by integrating real-time meteorological data with historical network data associated with prior weather patterns and their impact on network performance. This data, along with real-time network performance metrics, may be provided to the trained MLM, which may assist the monitor 242 in analyze patterns and correlations to determine the probability that the current weather pattern will affect one or more predefined coverage areas. For example, the monitor 242 may predict a probability of an additional terrestrial RAN node failing to connect one or more additional UE to the core network as a result of a current weather pattern. When the probability exceeds a threshold value, the monitor 242 may alert the controller 244, which may initiate preventative actions to mitigate potential network disruptions. These preventative actions may include instructing one or more non-terrestrial nodes, such as satellites 204, to adjust position and orientation as described herein, and to prepare to establish a communication link with the one or more additional UE within the terrestrial RAN node’s coverage area to maintain connectivity. Adjusting position and orientation may include changes to orbit, orientation, trajectory, altitude, inclination, or velocity. The controller 244 may further detect the satellites 204 to establish communication links with UE within the predefined coverage area, replacing terrestrial nodes as the serving RAN node. Additionally, the system may direct satellites 204 to position themselves along a predicted geographical path of the current weather pattern to provide coverage for one or more additional predefined coverage areas, enabling proactive network adjustments to minimize service degradation as the weather pattern evolves.

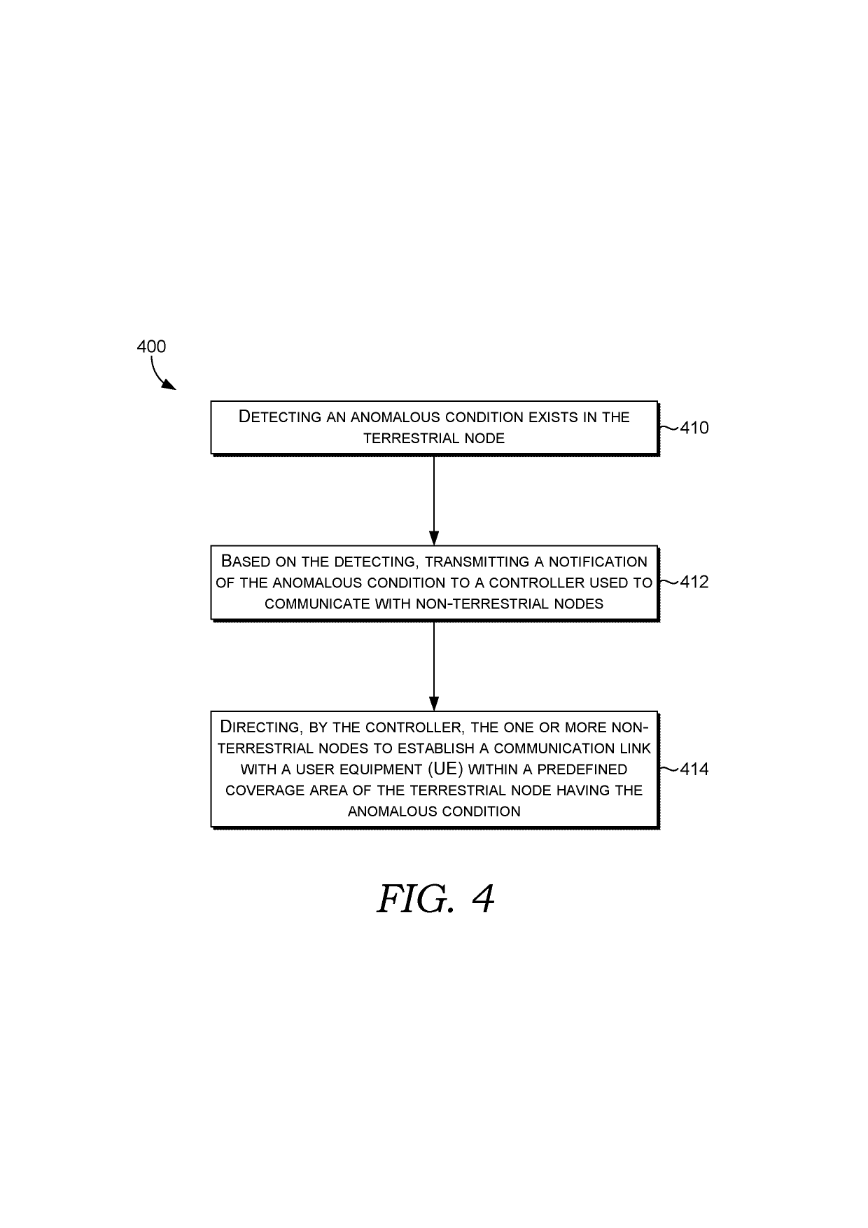

Turning now to FIG. 4, a flow chart representing a method 400 is provided. Generally, the method 400 may be used by a network for using one or more non-terrestrial nodes to supplement coverage of a terrestrial node. At step 410, a network monitor detects an anomalous condition exists in the terrestrial node. At step 420, based on the detecting, the monitor transmits a notification of the anomalous condition to a controller used to communicate with non-terrestrial nodes. At step 430, the controller directs the one or more non-terrestrial nodes to establish a communication link with a UE within a predefined coverage area of the terrestrial node having the anomalous condition.

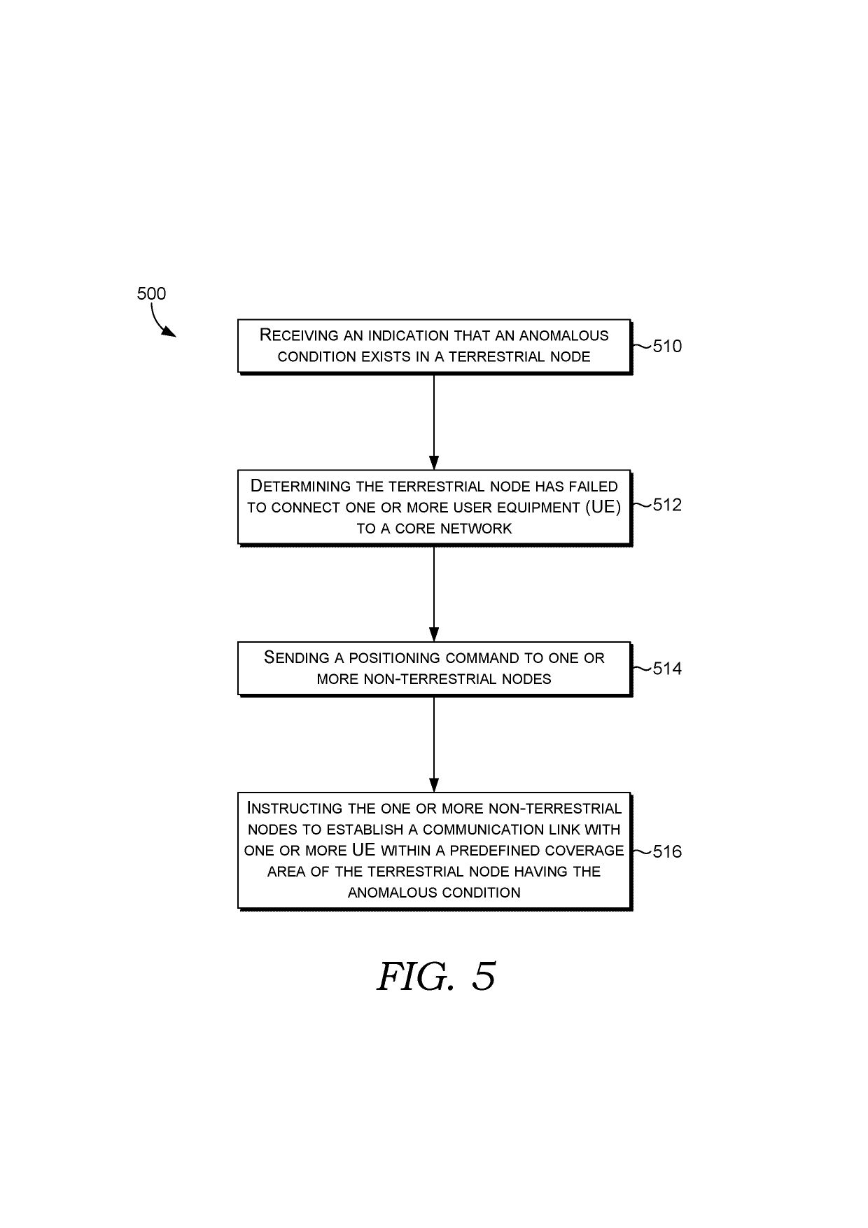

Turning now to FIG. 5, a flow chart representing a method 500 is provided. Generally, the method 500 may be used by a network for restoring network communication. At step 510, the network receives an indication that an anomalous condition exists in a terrestrial node. At step 520, the network determines the terrestrial node has failed to connect one or more UE to a core network. At step 530, the network sends a positioning command to one or more non-terrestrial nodes. At step 540, the network instructs the one or more non-terrestrial nodes to establish a communication link with one or more UE within a predefined coverage area of the terrestrial node having the anomalous condition.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

1. A method for using one or more non-terrestrial nodes to supplement coverage of a terrestrial node, the method comprising:
detecting an anomalous condition exists in the terrestrial node;
based on the detecting, transmitting a notification of the anomalous condition to a controller used to communicate with non-terrestrial nodes; and
directing, by the controller, the one or more non-terrestrial nodes to establish a communication link with a user equipment (UE) within a predefined coverage area of the terrestrial node having the anomalous condition.

2. The method according to claim 1, wherein the communication link facilitates data transmission to and from a core network associated with the terrestrial node.

3. The method according to claim 1, further comprising determining a root cause of the anomalous condition in the terrestrial node, wherein determining the root cause includes identifying one or more factors contributing to the anomalous condition based on historical network data and environmental data.

4. The method according to claim 3, further comprising predicting anomalies in one or more additional predefined coverage areas within a wireless communications network.

5. The method according to claim 4, further comprising directing one or more additional non-terrestrial nodes to provide supplemental coverage in the one or more additional predefined coverage areas.

6. The method according to claim 1, further comprising: detecting the anomalous condition no longer exists, and directing the one or more non-terrestrial nodes to terminate the communication link.

7. The method according to claim 1, wherein the terrestrial node is configured to provide wireless communication coverage over at least a portion of the predefined coverage area.

8. A method for restoring network communication, the method comprising:
receiving an indication that an anomalous condition exists in a terrestrial node;
determining the terrestrial node has failed to connect one or more user equipment (UE) to a core network;
sending a positioning command to one or more non-terrestrial nodes; and
instructing the one or more non-terrestrial nodes to establish a communication link with one or more UE within a predefined coverage area of the terrestrial node having the anomalous condition.

9. The method for restoring network communication of claim 8, wherein the positioning command includes instructions for the one or more non-terrestrial nodes to adjust orbit, orientation, trajectory, or velocity based on operational requirements.

10. The method for restoring network communication of claim 8, further comprising determining the terrestrial node failing to connect the UE to the core network is a result of a current weather pattern.

11. The method for restoring network communication of claim 10, further comprising, based on the current weather pattern, predicting a probability of an additional terrestrial node failing to connect one or more additional UE to the core network.

12. The method for restoring network communication of claim 11, further comprising when the probability exceeds a threshold value, instructing one or more additional non-terrestrial nodes to adjust position or orientation.

13. The method for restoring network communication of claim 12, further comprising, instructing one or more additional non-terrestrial nodes to prepare to establish a communication link with the one or more additional UE within a predefined coverage area of the additional terrestrial node.

14. A system comprising:
one or more processors;
computer memory storing computer-usable instructions that, when executed by the one or more processors, cause the one or more processors to perform operations comprising:
identifying a current weather pattern;
retrieving historical network data associated with prior network performance during prior weather patterns;
providing the current weather pattern, current network data, and historical network data associated with the prior network performance during prior weather patterns to a trained adaptive machine learning model; and
based on providing the current weather pattern, the current network data, and the historical network data associated with the prior network performance during prior weather patterns to the trained adaptive machine learning model, determining that the current weather pattern has a probability of affecting one or more predefined coverage areas.

15. The system according to claim 14, wherein the historical network data includes metrics related to availability of power, connectivity status, and coverage area performance.

16. The system according to claim 14, wherein the trained adaptive machine learning model is configured to identify correlations between weather patterns and network performance.

17. The system according to claim 14, further comprising alerting a network controller when the probability exceeds a threshold value.

18. The system according to claim 17, wherein the network controller initiates preventative action in response to the probability exceeding a threshold value, and wherein the preventative action include directing one or more non-terrestrial nodes positioned within a non-terrestrial network to adjust position and adjust orientation.

19. The system according to claim 18, wherein the preventative action further includes directing the one or more non-terrestrial nodes positioned within the non-terrestrial network to establish a communication link with a user equipment (UE) within a predefined coverage area.

20. The system according to claim 18, wherein the preventative action includes directing one or more non-terrestrial nodes to position along a predicted geographical path of the current weather pattern.
